(19) United States
(12) Patent Application Publication
(10) Pub. No.: US 2024/0385290 A1
(43) Pub. Date: Nov. 21, 2024

(54) TEST ARRANGEMENT FOR TESTING A SURROUNDINGS SENSOR AND METHOD FOR TESTING A SURROUNDINGS SENSOR

(71) Applicant: dSPACE GmbH, Paderborn (DE)

(72) Inventors: Juergen SCHMIDT, Paderborn (DE); Tim FISCH, Paderborn (DE); Bernd STELLING, Paderborn (DE)

(73) Assignee: dSPACE GmbH, Paderborn (DE)

(21) Appl. No.: 18/664,932

(22) Filed: May 15, 2024

(30) Foreign Application Priority Data
May 15, 2023 (DE) 10 2023 112 701.2

(51) Int. Cl. G01S 7/40; G01S 7/497; G01S 7/52

(52) U.S. Cl. CPC G01S 7/4056; G01S 7/497; G01S 7/52004

(57) ABSTRACT

A test arrangement for testing a surroundings sensor. The test arrangement includes a receptacle for the surroundings sensor, which is configured to emit a surroundings signal. A first object simulator is configured to receive the surroundings signal as a first receive signal. A second object simulator is configured to receive the surroundings signal as a second receive signal. A processor is configured to ascertain a signal difference, in particular, a phase difference and/or a frequency difference, from the first and second receive signals, and to ascertain, as a function of the signal difference, a spatial relationship between the surroundings sensor, the first object simulator, and/or the second object simulator.

This nonprovisional application claims priority under 35 U.S.C. § 119 (a) to German Patent Application No. 10 2023 112 701.2, which was filed in Germany on May 15, 2023, and which is herein incorporated by reference.

### BACKGROUND OF THE INVENTION

### Field of the Invention

The application relates to a test arrangement for testing a surroundings sensor as well as a method for testing a surroundings sensor using a test arrangement of this type.

### Description of the Background Art

Vehicles which include advanced driver assistance systems (ADAS), for example for autonomous or semi-autonomous driving, may have different surroundings sensors for capturing the surroundings, such as radar sensors, ultrasonic sensors, LIDAR sensors, and/or cameras.

A possibility for testing surroundings sensors for vehicles is to test the corresponding sensors in the installed state during test drives. This is laborious and cost-intensive.

A test arrangement may support the development of surroundings sensors with the aid of, for example, function tests. The test arrangement may simulate the operation of the surroundings sensors under different environmental or application conditions.

### SUMMARY OF THE INVENTION

It is therefore an object of the present invention to provide a test arrangement for testing a surroundings sensor that includes: a receptacle for the surroundings sensor, which is configured to emit a surroundings signal; a first object simulator, which is configured to receive the surroundings signal as a first receive signal; a second object simulator, which is configured to receive the surroundings signal as a second receive signal; and a processor, which is configured to ascertain a signal difference, in particular, a phase difference and/or a frequency difference, from the first and second receive signals, and to ascertain, as a function of the signal difference, a spatial relationship between the surroundings sensor, the first object simulator, and/or the second object simulator.

Information about a spatial relationship between the surroundings sensor and one, two, or more object simulators in the test arrangement may be obtained therefrom. Due to the object simulator(s), an object in the surroundings of the surroundings sensor may be simulated, using this information, in that the object simulator or the object simulators emit(s) suitable signals in the direction of the surroundings sensor.

A method for testing the surroundings sensor using the test arrangement includes: emitting a surroundings signal by the surroundings sensor; receiving the surroundings signal by a first object simulator; receiving the surroundings signal by a second object simulator; ascertaining a signal difference, in particular a phase and/or a frequency difference, from the first and the second receive signals; and ascertaining a spatial relationship between the surroundings sensor, the first object simulator, and/or the second object simulator as a function of the signal difference.

Due to the object simulator or object simulators, an object in the surroundings of the surroundings sensor may be simulated, using the information about the spatial relationship, in that the object simulator or the object simulators emit(s) suitable signals in the direction of the surroundings sensor. An object in the surroundings of the surroundings sensor is simulated therefor via the signals emitted by the object simulators. The location of the simulated object may be simulated precisely and flexibly by the exact knowledge of the spatial relationship between the object simulators and the surroundings sensor.

A use of a mechanical positioning device for the object simulators and the surroundings sensor may be avoided by means of the test arrangement and the method for testing the surroundings sensor. In other words, the use of the test arrangement or the method for testing the surroundings sensor makes a mechanical specification of a spatial arrangement unnecessary. The use of additional hardware, such as a laser, a camera, or an ultrasonic sensor, for determining the position of the surroundings sensor as well as the object simulators may thus be avoided. In particular, the test arrangement as well as the method for testing the surroundings sensor may be provided with a passive design, i.e., the surroundings sensor to be tested is not influenced by the test arrangement or the method for testing the surroundings sensor. Instead, the signals already present in any case are used. It is advantageously possible to implement the subject matter of the present application by means of a software update in existing test arrangements. The test arrangement or the method makes it possible to easily implement different positions of objects to be simulated by the object simulators on a predefined locus.

The test arrangement can be an apparatus which includes mechanical and electric components for testing a surroundings sensor. Many tests may be carried out thereby, for which test drives are no longer necessary, for example in applications of the surroundings sensor in vehicles. The test arrangement therefore includes a receptacle for the surroundings sensor, which permits the defined placement of the surroundings sensor, and a space for the surroundings sensor, into which the surroundings signals are then emitted. This space may be defined by walls. However, it may also be an open space. The receptacle, which mechanically and electrically connects the surroundings sensor to the test arrangement, may be an adapter which permits the installation of different surroundings sensors in the test arrangement. Different receptacles may correspondingly be provided for different surroundings sensors, which are used accordingly.

The surroundings sensor can be, for example, a radar sensor, a LIDAR sensor, an ultrasonic sensor, and/or a camera sensor. In particular, an FMCW radar may be used in a radar sensor for vehicles. A frequency modulation having a continuous signal or continuous wave signal is used for an FMCW radar.

The test arrangement can further include a first object simulator, which is configured to receive the surroundings signal emitted by the surroundings sensor as a first receive signal. The surroundings signal is attenuated at the location of the first object simulator, at least in terms of its amplitude, as a function of the distance between the surroundings sensor and object simulator. In particular, it may be provided that this first object simulator returns a signal which simulates a reflection of the surroundings signal on a simulated object. The second object simulator is configured correspondingly. More than two object simulators may be arranged in the test arrangement. The described method may be correspondingly applied to these more than two object simulators. Due to the return of the particular signals by the first and second object simulators, the object to be simulated may be simulated with a predefineable position in the surroundings of the surroundings sensor.

The test arrangement also can include a processor, which is configured to ascertain a signal difference from the first and second receive signals. The processor may be arranged separately from the first and second object simulators. The processor may also be arranged in one of the object simulators or it may be designed to be distributed over the object simulators. A distributed arrangement over the object simulators and a processor arranged separately from the object simulators are also possible. In the case of a distributed arrangement, the processor may be made up, for example, of different computing units, which are placed in the object simulators and/or remotely therefrom. The processor may therefore include one or multiple microprocessors and/or signal processors and/or other hardware circuits, for the purpose of deriving the signal difference from the first and second receive signals and ascertaining a spatial difference between the surroundings sensor, the first object simulator, and/or the second object simulator from the signal difference. For this purpose, the processor has a sufficiently fast data link to the particular object simulator or the particular object simulators, which may be arranged separately from the processor.

The same applies to the method for testing the surroundings sensor.

The measures and refinements recited in the dependent claims allow for advantageous improvements on the test arrangement specified in the independent patent claims or the method specified in the independent claims for testing the surroundings sensor.

It may be provided that the processor can be configured to ascertain a distance value, in particular a difference in the radial distance to the surroundings sensor, as the spatial relationship between the first and second object simulators. As a result, it is then possible to simulate objects in the visual range of the surroundings sensor in a targeted manner with the aid of the object simulators and to test the surroundings sensor thereby.

It may furthermore be provided that the processor can have a cross-correlation system for ascertaining the phase difference. The cross-correlation system includes a component for ascertaining the cross-correlation, a so-called cross-correlator, with the aid of which the phase difference of two signals may be ascertained. In signal processing, a correlation designates a relationship between two or multiple temporal or spatial functions. The cross-correlation relates to a function which is correlated with a function having the same waveform, shifted in time or space. The correlation integral is, for example, the basis for how similar the different functions are. For example, received electromagnetic waves, in the present case the receive signals, are correlated with each other. Temporal signal sequences are correlated. One example is the processing of radar signals. For example, the radar signals received by the two object simulators are compared. This makes it possible to ascertain the time shift between the two receive signals.

It is also possible that, to ascertain the frequency difference, the processor uses a mixer for the first and second receive signals or signals derived therefrom in each case. A mixer may be used to mix down the signals into an intermediate frequency range, in which the processing is easier than in the case of the receiving frequency, since the intermediate frequency has a lower frequency. In the case of an additive mixing, the intermediate frequency is added step by step with a frequency originating from a local oscillator and subsequently distorted at a component having a nonlinear characteristic curve. Due to the nonlinear distortion, a multiplicity of mixing frequencies arise from the sum of the two individual frequencies, which are suitably filtered through a downstream bandpass filter. A diode having an exponential characteristic curve may be used as the nonlinear component. This may also be simulated by software in the signal processing system. A multiplicative mixing is also possible, the two input signals then being multiplied by each other. The result is a sum and difference of the two frequencies, which may be separated by a downstream bandpass filter. Examples are a ring modulator or a so-called Gilbert cell. This may also be simulated in software.

It may be provided that the first and second object simulators each can include a receiver for receiving a surroundings signal. The first object simulator includes a first receiver for receiving a first receive signal. The second object simulator includes a second receiver for receiving a second receive signal. Receivers of this type may each include, for example, an antenna. This is necessary or at least helpful, in particular, in the case of radar signals. A light receiver is necessary for LIDAR signals and a converter for ultrasonic signals, which converts the ultrasonic signal into an electrical signal. The first receiver includes a first signal processing system. The second receiver includes a second signal processing system. The particular signal processing system is designed to receive the particular first and second receive signals. The first and second signal processing systems may be implemented by software, at least in part.

It may be provided that the particular signal processing system can be designed to receive the particular first or second receive signal for a predefineable period of time. As a result, the surroundings signal is not always received, but only if preconditions have been met. These preconditions may be detected, for example, by a trigger circuit, the trigger circuit starting and/or stopping the receipt of the first and second receive signals as a function of the particular receive signal. Conditions of this type may be, for example, the signal strength of the surroundings signal at the location of the first or second object simulator. The trigger circuit may be implemented in the first or second object simulator. The reception of the surroundings signal in the particular remote object simulator may be started and/or stopped via a data link between the first and second object simulators. The data link between the first and second object simulator may optionally also take place via the external processor.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a first block diagram of the test arrangement;

FIG. 2 shows a block diagram of the processor;

FIG. 3 shows a further block diagram of the processor;

FIG. 4 shows a flow chart of the method; and

FIGS. 5a through 5c show examples of signal curves of the particular receive signal and the cross-correlation signal.

### DETAILED DESCRIPTION

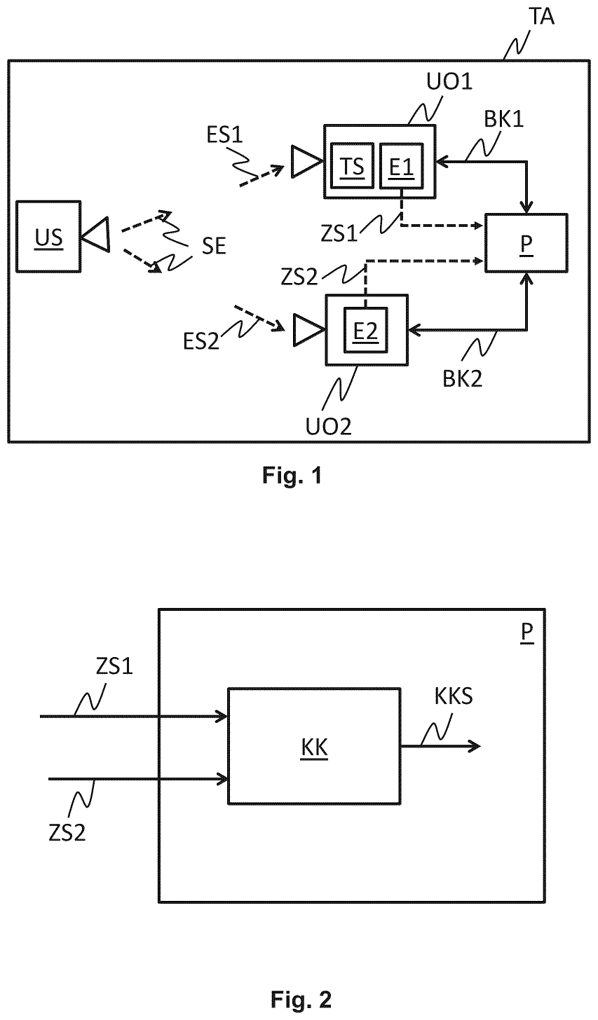

FIG. 1 shows a block diagram of test arrangement TA, including a surroundings sensor US, which emits surroundings signal SE into a space which defines or specifies test arrangement TA. The space may be unlimited. Surroundings sensor US is, for example, a radar sensor, and surroundings signal SE is therefore a radar signal.

Surroundings signal SE is received by a first object simulator UO1 as first receive signal ES1, a trigger circuit TS checking whether first receive signal ES1 is such that receiver E1 is to receive received first receive signal ES1. This condition may be, for example, that first receive signal ES1 has a minimum signal strength at the location of first object simulator UO1. For this purpose, the trigger circuit may include, for example, a threshold switch, which enables the reception of first receive signal ES1 as long as this minimum signal strength is reached or exceeded.

First receiver E1 then transmits a first intermediate signal ZS1 to processor P. First intermediate signal ZS1 is derived from first receive signal ES1. This derivation may be implemented by a frequency shift and other signal processing steps. In particular, first intermediate signal ZS1 is transmitted in an intermediate frequency range which is lower than the frequency range of first receive signal ES1. This simplifies the further processing of first intermediate signal ZS1.

First object simulator UO1 is in communication with processor P, i.e., a bidirectional data exchange BK1 between processor P and first receiver E1 exists in addition to the unidirectional transmission of first intermediate signal ZS1 or a signal derived therefrom. However, it is possible that only the unidirectional transmission of intermediate signal ZS1 is provided.

Second object simulator UO2 correspondingly receives surroundings signal SE as a second receive signal ES2. In the illustrated example, second receive E2 and no trigger circuit is arranged in second object simulator UO2. The reception of second receive signal ES2 may be started and/or stopped in the same way as the reception of first receive signal ES1, for example by trigger circuit TS in first object simulator UO1. The communication for this purpose may take place, for example, via processor P or via a direct connection of trigger circuit TS to second receiver E2.

This receiver E2 transmits second intermediate signal ZS2 to processor P. A bidirectional communication BK2 is also possible between processor P and second object simulator UO2. However, it is possible that only the unidirectional transmission of intermediate signal ZS2 is provided. Second intermediate signal ZS2 is derived from second receive signal ES2. This derivation may be implemented by a frequency shift and other signal processing steps. In particular, second intermediate signal ZS2 is transmitted in an intermediate frequency range which is lower than the frequency range of second receive signal ES2. This simplifies the further processing of second intermediate signal ZS2. Second intermediate signal ZS2 is preferably formed in a similar way to first intermediate signal ZS1.

It may also be provided that object simulators UO1 and UO2 receive surroundings signal SE as particular receive signals ES1 and ES2 continuously. Trigger circuit TS is optional. The functionality of second object simulator UO2 may be designed to be identical to or different than that of first object simulator UO1.

FIG. 2 shows a block diagram of processor P, which generates a cross-correlation signal KKS from the two intermediate signals ZS1 and ZS2 via a cross-correlation system KK. A signal difference between first intermediate signal ZS1 and second intermediate signal ZS2, and thus between first receive signal ES1 and second receive signal ES2, may then be ascertained from this cross-correlation signal KKS.

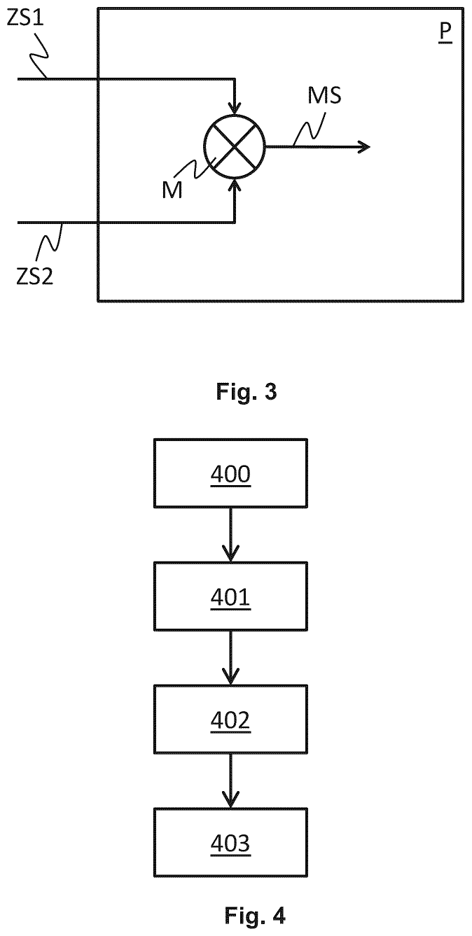

FIG. 3 shows an alternative to cross-correlation system KK. A mixer M is now implemented by software in processor P, which, as illustrated above, may be designed to be either additive or multiplicative. The two intermediate signals ZS1 and ZS2 are mixed, and the mixer results are output in a filtered manner as mixer signal MS. The signal difference, for example the phase difference or frequency difference, may then be ascertained from mixer signal MS. For example, the mixer products have the phase difference as a result. The latter may then be evaluated directly.

The method for testing a surroundings sensor is illustrated as a flowchart in FIG. 4. Surroundings signal SE is emitted by surroundings sensor US in method step 400. In method step 401, surroundings signal SE is received in each case by first object simulator UO1 and second object simulator UO2 as first or as second receive signal ES1, ES2. The ascertainment of a signal difference, in particular a phase difference and/or a frequency difference, from first and second receive signals ES1, ES2 takes place in method step 402. The ascertainment of a spatial relationship between surroundings sensor US, first object simulator UO1, and/or second object simulator UO2 then takes place in method step 403 as a function of this signal difference.

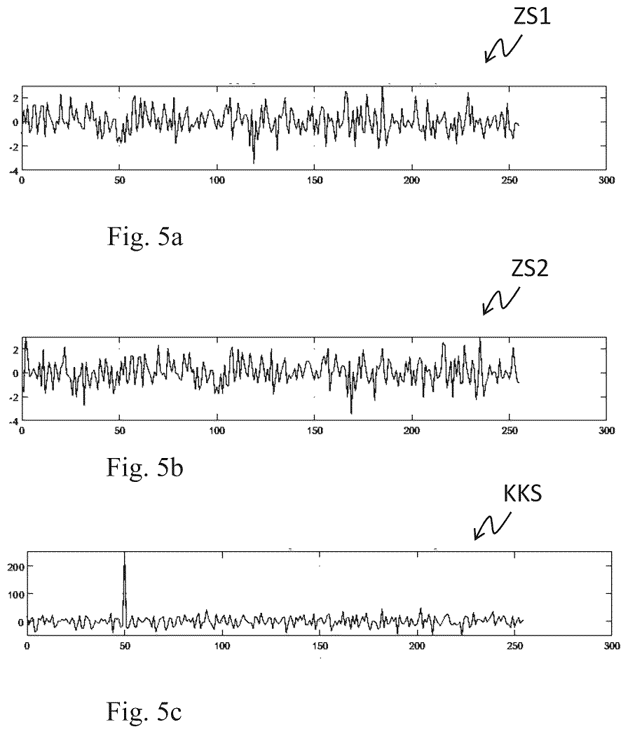

FIG. 5a shows first intermediate signal ZS1, for example, as an amplitude-time signal. This means that the amplitude is plotted on the ordinate and time on the abscissa. FIG. 5b correspondingly shows an example of second intermediate signal ZS2 in a corresponding amplitude-time diagram. As described above, a cross-correlation signal KKS, which is illustrated in FIG. 5c, is now determined from intermediate signals ZS1 and ZS2 by processor P. The time difference, which cross-correlation signal KKS shows at 50 on the abscissa, is clearly apparent. This may be, for example, milliseconds.

The simulation of different positions of simulated objects on a predefined locus may be easily implemented by the proposed test arrangement or the proposed method for testing a surroundings sensor. For example, to simulate objects arranged in a circular manner around the surroundings sensor, an object simulator may be moved on a straight line in front of the surroundings sensor. With the aid of the other object simulator, which has a fixed distance to the surroundings sensor, the distance from the moving object simulator to the surroundings sensor may be, for example, repeatedly determined after a one-time calibration. The parameters for the moving object simulator may thus be adapted for the transmission power and the simulated distance in such a way that the simulated object moves in the center around the surroundings sensor along a circular segment from the perspective of the surroundings sensor. The simulated object is perceived by the surroundings sensor in that it receives the superimposed signals emitted by the two object simulators.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A test arrangement to test a surroundings sensor, the test arrangement comprising:
a receptacle for the surroundings sensor, which is configured to emit a surroundings signal;
a first object simulator, which is configured to receive the surroundings signal as a first receive signal;
a second object simulator, which is configured to receive the surroundings signal as a second receive signal;
a processor, which is configured to ascertain a signal difference, in particular, a phase difference and/or a frequency difference, from the first and second receive signals, and to ascertain, as a function of the signal difference, a spatial relationship between the surroundings sensor, the first object simulator, and/or the second object simulator.

2. The test arrangement according to claim 1, wherein the processor is configured to ascertain a distance value or a difference in the radial distance to the surroundings sensor, as the spatial relationship between the first and second object simulators.

3. The test arrangement according to claim 1, wherein the processor includes a cross-correlation system for ascertaining the phase difference.

4. The test arrangement according to claim 1, wherein the processor uses a mixer for the first and second receive signals or signals derived therefrom in each case to ascertain the frequency difference.

5. The test arrangement according to claim 1, wherein the first and second object simulators each include a receiver to receive the surroundings signal, the first and second receivers each including a particular signal processing system, which is designed to receive the particular first or second receive signal.

6. The test arrangement according to claim 5, wherein the particular signal processing system is designed to receive the particular first or second receive signal for a predefineable time.

7. The test arrangement according to claim 5, wherein one of the receivers includes a trigger circuit, which starts and/or stops the reception of the first and second receive signals as a function of the particular receive signal.

8. A method to test a surroundings sensor with the aid of a test arrangement, the method comprising:
emitting a surroundings signal by the surroundings sensor;
receiving the surroundings signal by a first object simulator;
receiving the surroundings signal by a second object simulator;
ascertaining a signal difference, in particular a phase difference and/or a frequency difference, from the first and the second receive signals; and
ascertaining a spatial relationship between the surroundings sensor, the first object simulator, and/or the second object simulator as a function of the signal difference.

9. The method according to claim 8, wherein a distance value or a difference in the radial distance to the surroundings sensor is ascertained as the spatial relationship between the first and second object simulators.

10. The method according to claim 8, wherein the phase difference is ascertained with the aid of a cross-correlation system.

11. The method according to claim 8, wherein the first and second receive signals or signals derived therefrom in each case are mixed with the aid of a mixer (M) for the purpose of ascertaining the frequency difference.

12. The method according to claim 8, wherein the first and second object simulators each include a receiver to receive the surroundings signal, and wherein the first and second receive signals each being received by a particular signal processing system of the particular receiver.

13. The method according to claim 12, wherein the particular receive signal is received for a predefineable time.

14. The method according to claim 12, wherein the beginning and/or end of the reception of the first and second receive signals is/are triggered by one of the receivers as a function of the particular receive signal.
